(19) United States
(12) Patent Application Publication
(10) Pub. No.: US 2009/0077532 A1
(43) Pub. Date: Mar. 19, 2009

(54) AUTOMATED ANNOTATION INFERENCE FOR SAFETY CERTIFICATION OF AUTOMATICALLY GENERATED CODE

(75) Inventors: Ewen DENNEY, Mountain View, CA (US); Bernd Fischer, Southampton (GB)

Correspondence Address: SUGHRUE MION, PLLC, 2100 PENNSYLVANIA AVENUE, N.W., SUITE 800, WASHINGTON, DC, 20037, US

(73) Assignee: UNIVERSITIES SPACE RESEARCH ASSOCIATION, Columbia, MD (US)

(21) Appl. No.: 12/209,674

(22) Filed: Sep. 12, 2008

Related U.S. Application Data
(60) Provisional application No. 60/960,056, filed on Sep. 13, 2007.

(51) Int. Cl. G06F 9/44

(52) U.S. Cl. 717/106; 717/126; 717/125

(57) ABSTRACT

Systems and methods for providing generic post-generation annotation inference for verification of auto-generated code by automatically inferring safety annotations used to prove software safety. The inferred logical annotations are obtained by taking into account code patterns and safety requirements. The locations for inserting the annotations in the auto-generated code are obtained by using the code patterns to produce a flow graph of the result sensitive variables and the paths to all their corresponding definitions. The verification is customized to reduce unwarranted warnings by imposing no inherent restriction on the precision. A detailed report of verification of the auto-generated code is generated to permit independent verification and validation by a third party. The method operates independently from a model used to generate the code or internal templates of the code generator. The system may use untrusted components for inferring annotations and annotating the code.

### CROSS-REFERENCE TO RELATED APPLICATION

This application claims priority to and the benefit of the U.S. Provisional Patent Application No. 60/960,056, filed on Sep. 13, 2007, in the U.S. Patent and Trademark Office, the entire content of which is incorporated by this reference.

### STATEMENT REGARDING FEDERALLY SPONSORED RESEARCH OR DEVELOPMENT

The U.S. Government has a paid-up license in this invention and the right in limited circumstances to require the patent owner to license others on reasonable terms as provided for by the terms of the grant or cooperative agreement number NCC 2-1426 by the National Aeronautics and Space Administration (NASA).

### BACKGROUND

1. Field of the Invention

This invention relates generally to the fields of verification and validation and more particularly to formal verification of automatically generated code.

2. Description of Related Art

Software verification may be used to ascertain that a piece of software satisfies expected requirements. Formal verification is a category of verification which proves the correctness of algorithms underlying a system with respect to a formal requirement using formal methods of mathematics.

Code generation converts some internal representation of a source code into a form that can be readily executed by a machine. Automatic programming or auto-generation may refer to a type of computer programming where some mechanism generates a computer program rather than human programmers writing the code.

Model-based design and automated code generation are being used increasingly in safety-critical contexts. They promise many benefits, including higher productivity, reduced turn-around times, increased portability, and elimination of manual coding errors. There are numerous successful applications of both in-house custom generators for specific projects, and generic commercial generators.

Code generators have traditionally been used for rapid prototyping and design exploration, or the generation of certain kinds of code such as user interfaces, stubs, header files, and the like. However, there is a clear trend now to move beyond simulation and prototyping to the generation of production code, particularly in the embedded control domain.

Nevertheless, there remain substantial obstacles to more widespread adoption of code generators in such safety-critical domains. One of the remaining obstacles is assuring that auto-generated code is correct.

Ideally, the code generator, itself, should be qualified. However, this is a non-trivial and expensive process, and is therefore rarely done. In instances where the code generator itself is qualified, the qualification is only specific to the use of the generator within a given project, and needs to be redone for every project and for every version of the generator. Further, even if a code generator is generally trusted, user-specific modifications and configurations necessitate that verification and validation (V&V) be carried out on the generated code.

Verification looks for errors in a code and reports the errors while certification provides a guarantee that no errors are found. Certification also provides evidence of mathematical proof and documentation. Certification requires more than black box verification of selected properties, otherwise trust in one tool, namely the generator, is simply replaced with trust in another, namely the verifier. Moreover, some understanding of why the code is safe helps the larger certification process. However, without generator qualification the regeneration of code after the model has been modified can require complete recertification, which offsets many of the advantages of using a generator. Finally, testing the generator itself can require detailed knowledge of the transformations it applies. Therefore, the direct V&V of code generators is too laborious and complicated due to their complex and often proprietary nature.

As a result, code generators for realistic application domains are not directly verifiable in practice. In the certifiable code generation approach, the generator is extended to generate logical annotations along with the programs, allowing fully automated program proofs of different safety properties. However, this requires access to the generator sources, and remains difficult to implement and maintain.

Because the direct verification of generators is unfeasible with existing verification techniques, several alternative approaches based on “correct-by-construction” techniques like deductive synthesis or refinement have been explored. However, these remain difficult to implement and to scale up, and have not found widespread application. Currently, generators are thus validated primarily by testing, but this quickly becomes excessive and cannot guarantee the same level of assurance as logical techniques.

Because code generators are typically not qualified, there is no guarantee that their output is correct, and consequently the generated code still needs to be fully tested and certified.

In the certifiable code generation approach, the generator, itself, is extended to generate logical annotations along with the programs, allowing fully automated program proofs of different safety properties. However, this requires access to the generator sources, and remains difficult to implement and maintain.

Although general-purpose V&V technology can be used to verify auto-generated code, there are numerous problems with current tools. First, they have an unacceptably high level of false positives. Second, for code which is actually safe they do not provide any independently verifiable evidence, such as explicit certificates. They may only provide a simple “yes” or an obscure internal status information. Third, it is difficult to customize these tools for specific safety properties. Some static analysis tools have the capability to specify new properties using syntactic patterns but this usually requires extensions to the analysis algorithm, thus substantially increasing the effort to customize the tools. Fourth, these tools are monolithic and often proprietary software systems, and thus difficult to qualify such that trust is established in the tool itself.

Logical annotations were recognized early on as one of the bottlenecks in program verification. Early methods used inference rules similar to a strongest post-condition calculus to push an initial logical annotation forward through the program. However, these methods induce a search space at inference time and the constructed annotations are often only candidate invariants which need to be validated or refuted during inference.

Abstract interpretation has also been used to infer annotations although the techniques required for abstract interpretation are fairly specialized and elaborate.

Finally, generate-and-test methods have also been applied to the problem of inferring annotations. Here, a generator phase uses a fixed pattern catalogue to construct candidate annotations while a test phase tries to validate (or refute) them, using dynamic or static methods. In general, however, dynamic annotation generation techniques remain incomplete because they rely on a test suite to generate the candidates and can thus miss annotations on paths that are not executed at all or are not executed often enough.

### SUMMARY

Certain embodiments of the present invention provide methods and systems for certifying an automatically generated code that are independent of the code generator. These embodiments separate code generation and independent V&V and access to internal details of the generator is generally not needed for the V&V process. Instead, the aspects of the present invention exploit the idiomatic nature of the generated code to automatically infer logical annotations that are used for formally verifying code safety.

Various embodiments of the present invention provide methods and systems that work automatically. The combination of annotation inference with powerful automatic theorem provers (ATPs) obviates the need for user interaction such as manually writing annotations or manually guiding a theorem prover while traditional logic-based V&V techniques require manual intervention.

Aspects of the present invention provide methods and systems that use a small set of trusted components based on formal methods. Accordingly, trust does not depend on correctness of the annotations, but on the safety requirements supplied by the user and the verification condition generator (VCG) which expresses the semantics of the target language. The safety requirements may be concise. The generated certificates are provably correct and can be checked by an independent third party. Users do not need to understand the formal logical basis of the tool; rather, its analyses are explained in domain-specific terms suitable for code reviews or flight readiness reviews, in the form of a generated safety document.

Aspects of the present invention provide methods and systems that use formal logic to specify the safety properties. The safety properties are separated from the certification engine. This separation makes it possible to customize the methods and systems of the present invention to project-specific flight rules. Aspects of the present invention provide methods and systems that have no inherent limitations on the precision. As a result, the methods and systems of the present invention can deliver an analysis with few or no false alarms. Consequently, failed proof attempts, in most cases, point to an actual violation of a safety property. Aspects of the present invention thus provide a higher level of assurance than existing model-based testing tools or other external analysis tools. Conventional systems which achieve this high level of assurance via annotations that are manually provided by users carry an unacceptably high overhead.

One aspect of the present invention provides a system and a computer-implemented method for verification of an automatically generated computer code. An automatically generated code is received at an annotation engine together with safety requirements or safety properties provided by a safety module. The annotation engine takes advantage of the highly idiomatic characteristics of the automatically generated code to identify the code patterns of the code. Based on the safety requirements and the code patterns, the code constructs of the automatically generated code are described. Based on the code constructs, locations within the code are identified that are suitable for inserting annotations. The annotation engine further derives or infers logical annotations based on code patterns and the safety requirements. The inferred logical annotations are automatically inserted into the identified locations within the code to yield an annotated code. The annotated code is subsequently verified by a certification engine that may use a Hoare logic system. The annotated code generated by the annotation engine and a certificate generated by the certification engine are output by the system and the computer-implemented method for verification of the automatically generated computer code.

One aspect of the present invention includes a computer-readable medium, such as a physical storage medium, storing a computer program for performing the methods of the aspects of the invention.

### BRIEF DESCRIPTION OF THE DRAWINGS

The incorporated drawings constitute part of one or more embodiments of the invention. However, they should not be taken to limit the invention to a specific embodiment. The invention and its mode of operation will be more fully understood from the following detailed description when taken with the incorporated drawings in which like reference numerals correspond to like elements.

FIG. 1 shows a block diagram demonstrating a relationship between an auto-certification engine and a code generator of a post-generation annotation inference system, according to aspects of the present invention.

FIG. 2 shows a flow chart of a method of verification performed by the system of FIG. 1, according to aspects of the present invention.

FIG. 3A and FIG. 3B show a block diagram of system architecture of a post-generation annotation inference system, according to aspects of the present invention.

FIG. 4 shows a flow chart of a method of verification of an auto-generated code using generic post-generation annotation inference, according to aspects of the present invention.

FIG. 5 shows a flow chart of a method of identifying patterns in a code and inserting annotations in the code, according to the aspects of the present invention.

FIG. 6A and FIG. 6B show a flow chart of a method for generating inferred annotations and inserting inferred annotations in an auto-generated code, according to the aspects of the present invention.

FIG. 7 shows a flow chart of a method of carrying out Hoare Style certification in coordination with the aspects of the present invention.

FIG. 8 shows a flow chart of another overview of a method of verification of an auto-generated code using generic post-generation annotation inference.

FIG. 9 shows an exemplary embodiment of a computer platform upon which the inventive system may be implemented.

### DETAILED DESCRIPTION

Generic post-generation annotation inference methods and systems described here are adapted to being used for formal verification of an auto-generated code. Generic post-generation annotation inference methods described here exploit the highly idiomatic structure of automatically generated code and a restriction to specific safety properties.

High-level code patterns may be used to describe code constructs that require annotations. Patterns augmented with operations for constructing annotations can also be used to derive or infer the annotations that are used at particular pattern locations. Such extended patterns may also be referred to as annotation schemas. A combination of planning and techniques similar to aspect-oriented programming are used to add the annotations to the generated code. The patterns are specific to the idioms of the targeted code generator and to the safety property to be shown. For each safety property a library of patterns is available. The method itself, however, may remain generic.

The problem of certifying code can be split into two phases. The first phase is an untrusted annotation construction phase. The second phase is a trusted verification phase where the standard machinery of a VCG and an ATP may be used to prove that the code satisfies the safety property or the safety requirement. However, annotation generation can be concentrated in one location and leave the code generator unchanged. This is due to the fact that the methods and systems of the invention are capable of being executed separately from the code generator.

A generic approach is developed to extending code generators with a safety certification capability. A pattern matcher can be used to identify instances of the idioms and to build property-specific abstracted control flow graphs. Further a graph traversal can be used that follows the paths from the use nodes backwards to all corresponding definitions of each use node and annotates the statements along these paths using the annotation schemas.

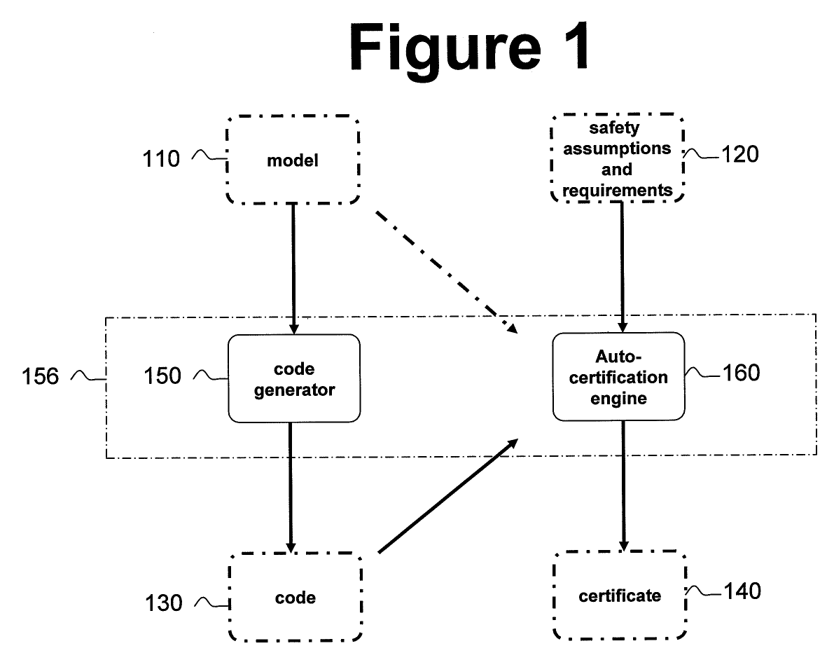

FIG. 1 shows a block diagram demonstrating a relationship between an auto-certification engine and a code generator of a post-generation annotation inference system, according to aspects of the present invention.

FIG. 1 provides a high-level view of the relationship between inputs and outputs of a system including a code generator and an auto-certification engine. The inputs to the system include a model 110 and safety assumptions and requirements 120. The outputs from the system include an automatically generated code 130 and a certificate 140 certifying the safety of the code 130. The system 156, shown with a dashed box, includes a code generator 150 and an auto-certification engine 160. The dashed box 156 indicates that the auto-certification engine 160 may be implemented as a plug-in that is a part of the code generator 150.

The code generator 150 and the auto-certification engine 160 may be engines implemented in hardware, as shown. These elements may also be implemented in software programs. Similarly, the model 110, the safety assumptions and requirements 120, the code 130 and the certificate 140 may be available on a storage medium. The model may represent a mathematical model of some features of a physical structure such as a car or a spacecraft. The generated code, then, would run on an embedded controller, for example in the car or the spacecraft.

The code generator 150 takes the model 110 as input and generates the code 130 which implements the model 110. The safety assumptions and requirements 120 include the safety assumptions. The auto-certification engine 160 checks and verifies the generated code 130 for compliance with these safety assumptions. In one aspect of the invention, the auto-certification engine 160 may also access the model 110 to obtain any other necessary information. In other aspects of the invention, the auto-certification engine does not access the model 110. The result of the analysis by the auto-certification engine 160 is the formal safety certificate 140. The certificate 140 provides mathematical proof and evidence that the generated code 130 is verified and in compliance with the safety requirements and therefore the code generator 150 is operating properly. The certificate 140 may further include tracing information between V&V artifacts and the code 130, and may provide an explanatory safety document.

As system 156 of FIG. 1 shows, techniques described here can be used to develop generator plug-ins to support the subsequent certification of the code created by the generator. This feature is in contrast to approaches based on directly qualifying the generator, itself, or on testing of the generated code. These techniques support certification by formally verifying that the generated code is free of different safety violations, by constructing an independently verifiable certificate, and by explaining the analysis that was performed in a textual form suitable for code reviews. These aspects provide assurance about the safety and reliability of the code without requiring excessive manual V&V effort and, as a consequence, increase the acceptance of code generators in safety-critical contexts. The generation of explicit certificates is particularly well-suited to supporting independent V&V.

In the flow charts that follow, the stages of the processes are separated and ordered for ease of description. Some of the stages may be performed simultaneously or may be interleaved.

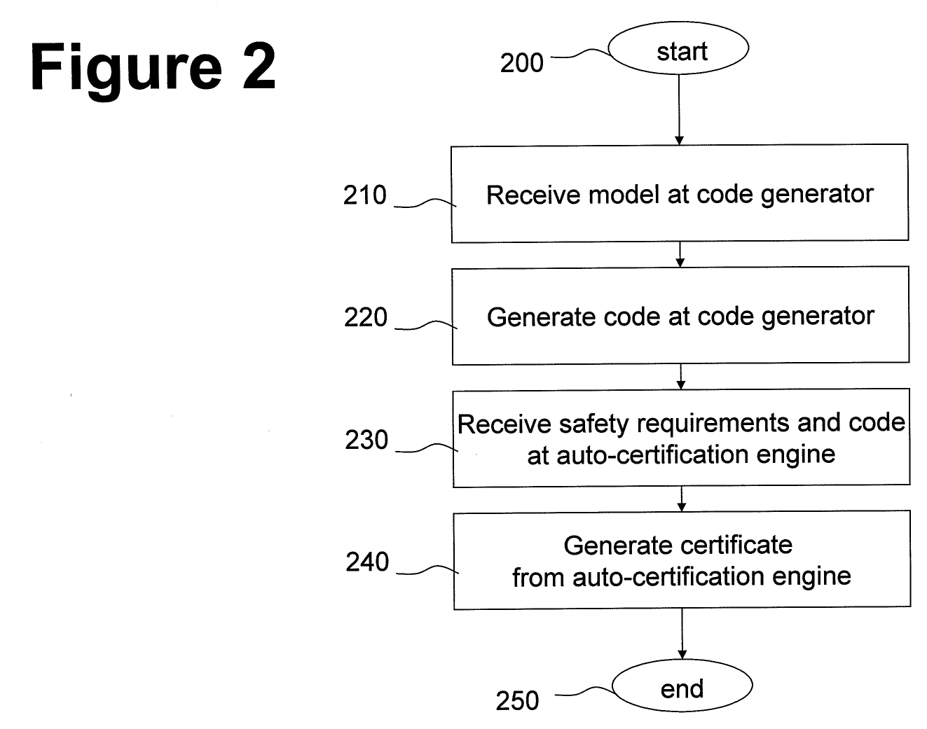

FIG. 2 shows a flow chart of a method of verification performed by the system of FIG. 1. Certification is an extension of the verification process where a system or a method is certified to be accurate through a process of verification. Verification merely searches for errors and may or may not certify the accuracy of a system or a method.

The method begins at 200. At 210, the model 110 is received at the code generator 150. At 220, the code generator 150 generates the code 130. At 230, the safety requirements and assumptions 120 and the code 130 are received at the auto-certification engine 160. In some aspects of the present invention, at 230, the auto-certification engine 160 may also access the model 110 for more information. At 240, the auto-certification engine 160 generates the certificate 140. At 250, the method ends.

System Architecture

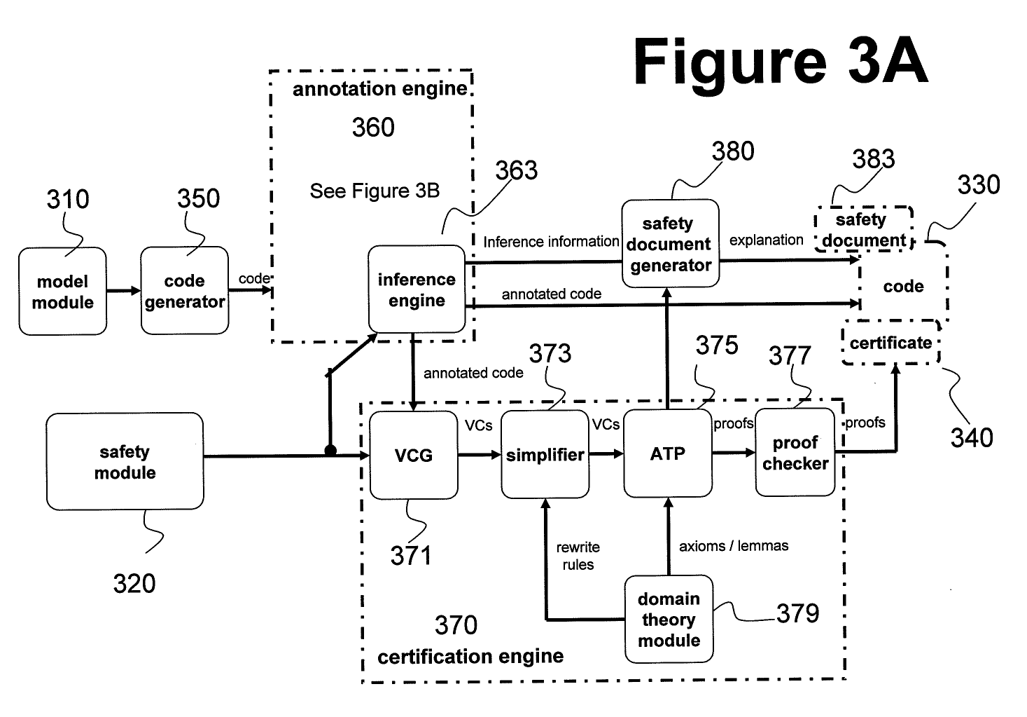

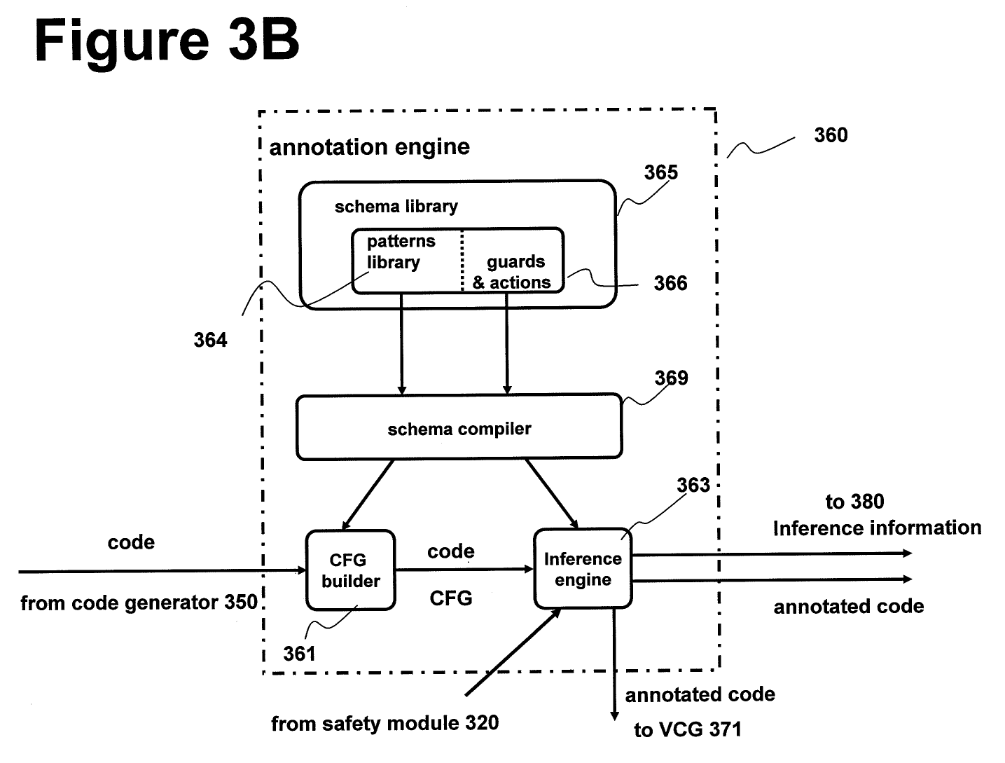

FIG. 3A and FIG. 3B show a block diagram of system architecture of a post-generation annotation inference system. FIG. 3A shows the overall system and FIG. 3B shows an inset of FIG. 3A that is directed to an annotation engine alone.

FIG. 3A and FIG. 3B show the overall system architecture. Inputs to the system are provided by a model module 310 and a safety module 320. Outputs of the system include a code 330 and an associated certificate 340. A code generator 350 receives a model, such as the model 110 of FIG. 1, from the model module 310 and generates an automatically generated code. The automatically generated code is input to an annotation engine 360 that generates an annotated code. The annotated code output by the annotation engine 360 is provided to a certification engine 370. The certification engine 370 also receives safety assumptions and requirements, such as the safety assumptions and requirements 120 of FIG. 1, from the safety module 320. The certification engine 370 verifies safety of the annotated code and generates the certificate 340 that is associated with the code 330 generated by the code generator 350 and annotated by the annotation engine 360. A safety document generator 380 is also shown that receives inference information from the annotation engine 360 and generates explanations that are ultimately produced as a safety document 383. The auto-certification engine 160 of FIG. 1 may correspond to a combination of the annotation engine 360 and the certification engine 370 of FIG. 3A.

FIG. 3B shows the annotation engine 360 in more detail. The annotation engine 360 includes a control flow graph (CFG) builder 361, an inference engine 363, a library of schemas 365 that includes a library of patterns 364 and guards and actions 366, and a schema compiler 369. The guards are conditions expressed in terms of variables in the patterns. The actions are calls to annotation construction operations.

A CFG is a representation of paths that might be traversed through a program during its execution. The CFG builder 361 receives the code from the code generator 350 and schemas from the schema compiler 369 and generates the CFG for the generated code by collapsing idioms matching patterns into nodes.

The schema library 365 includes the patterns from the patterns library 364 and a guards and actions section 366. The CFG builder 361 matches the code pattern of the code generated by the code generator 360 to the patterns in the pattern library, for which the guards hold on the matched code fragment, to find a pattern that matches the pattern of the code. The schema compiler 369 compiles the schemas and patterns and provides customized analysis and annotation routines to the CFG builder 361 and the inference engine 363.

The code and the CFG output from the CFG builder 361 enter the inference engine 363. The inference engine 363 also receives the safety assumptions and requirements from the safety module 320 and the schemas from the schema compiler 369 and generates an annotated code which is output from the system directly and through the certification engine 370. The annotated code is generated by executing the actions in the corresponding annotation schemas. The inference engine 363 infers or derives the annotations based on the safety requirements and the code patterns and inserts the annotations at appropriate nodes in the code to generate the annotated code. The inference engine 363 also produces inference information that is provided to the safety document generator 380.

Back to FIG. 3A, the certification engine 370 includes a VCG 371 coupled to a simplifier 373, an ATP 375 and a proof checker 377 in series. A domain theory module 379 provides input to the simplifier 373 and the ATP 375.

The certification engine 370 receives one input from the safety module 320 and another input from the inference engine 363 of the annotation engine 360. The annotated code output by the inference engine 363 and the safety properties from the safety module are input to the VCG 371 that generates the verification conditions (VCs). The VCs are input to the simplifier 373 and simplified before being input to the ATP 375. The domain theory module 379 provides rewritten rules to the simplifier 373 and axioms and lemmas, used for mathematical proof, to the ATP 375. The ATP 375 outputs proofs that are checked by the proof checker 377. The certificate 340 is output from the proof checker 377. The ATP 375 also provides its procedure to the safety document generator 380 for inclusion in the safety document 383. The certification engine 370 may use Hoare style logic.

In one embodiment of the invention, the system includes the original and unmodified code generator 350, which is complemented by the annotation inference engine 360 as well as the machinery for Hoare-style verification techniques of the certification engine 370. In another embodiment of the invention, the annotation inference engine 360 and the certification engine 370 may be plug-ins for the code generator 350.

The architecture distinguishes between trusted and untrusted components. Trusted components include the model module 310, the safety module 320, the VCG 371, the simplifier 373, the domain theory module 379 and the proof checker 377. It is more important that the trusted components are correct because errors in these components can compromise the assurance provided by the overall system. Untrusted components, on the other hand, are not crucial to the assurance because their results are double-checked by at least one trusted component. The untrusted components may include the elements of the annotation engine 360 and the code generator 350. The untrusted components may also include the ATP 375 of the certification engine 370.

The assurance provided by the approaches described here does not depend on the correctness of the original code generator 350 and the ATP 375 that may be the two largest and most complicated components. Instead, in this aspect, trust need only be placed in the safety module 320, the VCG 371, the domain theory module 379, and the proof checker 377. The simplifier 373 should also be trusted if it is used. Moreover, the annotation inference engine 360 may remain untrusted because the resulting annotations simply serve as “hints” for the subsequent analysis steps.

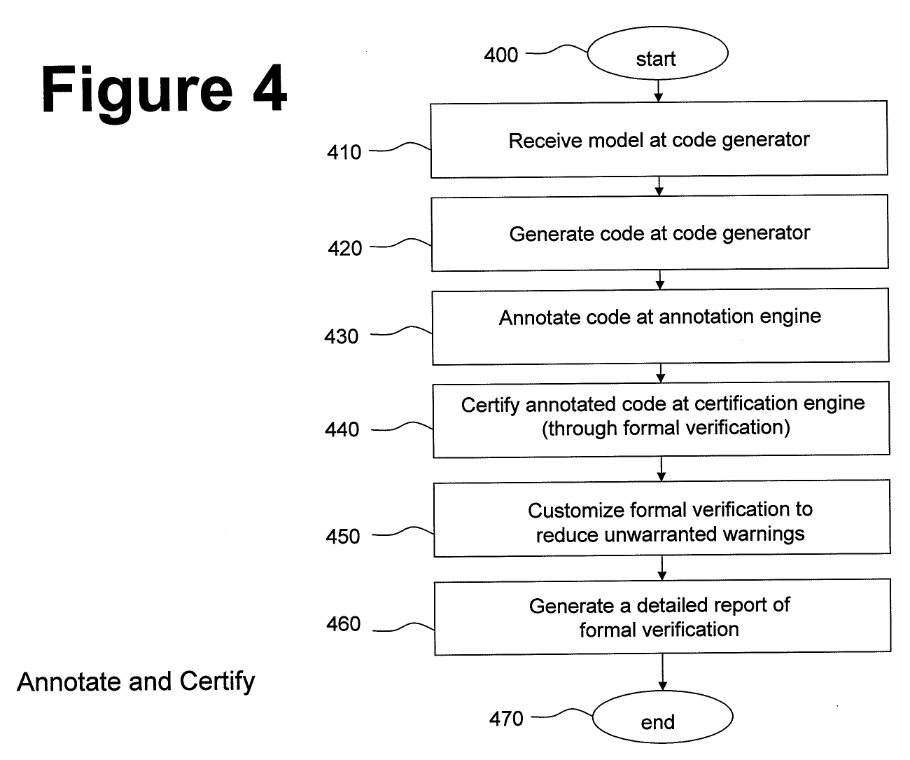

FIG. 4 shows a flow chart of a method of verification of an auto-generated code using generic post-generation annotation inference. The method of FIG. 4 may be carried out by the system shown in FIG. 3A and FIG. 3B.

The method begins at 400.

At 410, a model is received at a code generator. The model corresponds to a physical feature of a device or phenomenon. For example, the model may attempt to define a spacecraft or an automobile.

At 420, an automatically generated code is generated by the code generator. The code generator receives the model and uses its own internal templates to generate the code.

At 430, the automatically generated code is annotated at an annotation engine such as the annotation engine 360 of FIG. 3A.

At 440, the annotated code is certified at a certification engine. The certification may be achieved through formal verification.

At 450, the formal verification is customized to reduce unwarranted warnings generated by the certification process. Unwarranted warnings are false positives.

At 460, a detailed report of the certification through formal verification is generated that is usable by a human operator for understanding both the errors and the automatically generated code. The detailed report may be used for an independent validation of the certification process.

At 470, the method ends.

Related to 450, customizing the schema library is an iterative process. The user will first attempt to verify a representative sample of the auto-generated code for the properties of interest. If the necessary schemas are missing, the tool will indicate this in the form of errors which can be traced to specific lines of code. These correspond to missing annotations. The corresponding code fragments can then be identified, and generalized as high-level patterns in order to capture some variability. Annotation schemas based on these patterns, and extended with pre-defined annotation construction operators, embodying standard induction principles, can then be written. The analysis can be run again, and additional schemas written as necessary, until the desired precision is reached.

Idiomatic Code and Automated Code Certification

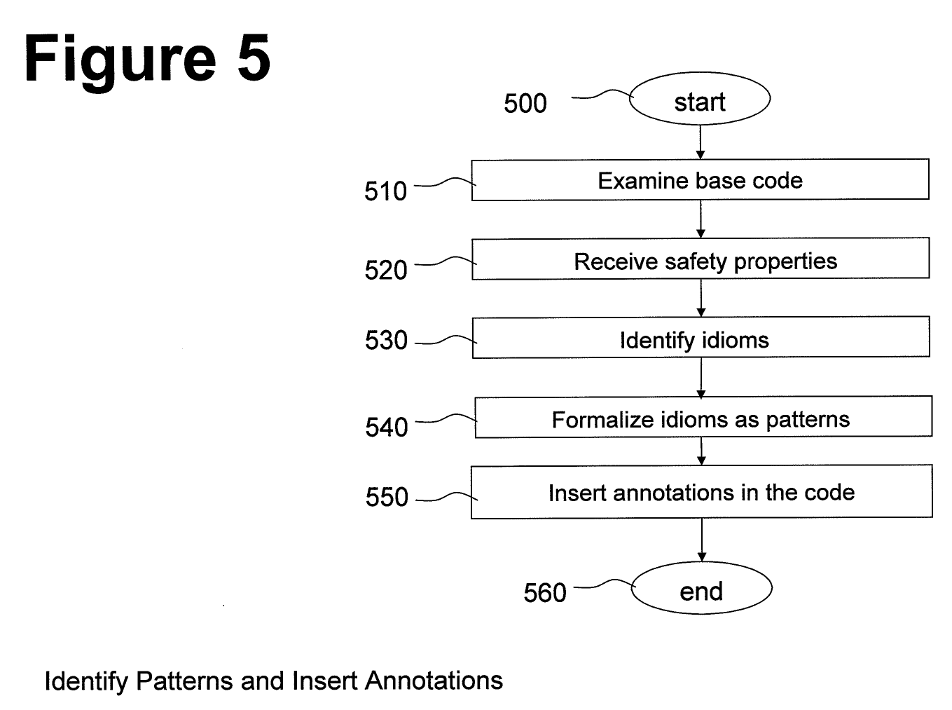

FIG. 5 shows a flow chart of a method of identifying patterns in a code and inserting annotations in the code. The method derives patterns from idioms and matches the patterns to a generated code.

The method of FIG. 5 may be carried out by an annotation engine, such as the annotation engine 360 of FIG. 3A.

The method begins at 500.

At 510, a base code is examined. The base code is an automatically generated code. Automatically generated codes are typically highly idiomatic.

At 520, safety assumptions and safety properties are received.

At 530, idioms in the code are identified based on the safety properties.

At 540, the idioms are formalized as patterns.

At 550, the method identifies nodes within the code where the annotations are to be inserted, the logical annotations needed for verification of the code are automatically inferred, and the inferred logical annotations are inserted at the nodes identified and an annotated code is obtained.

At 560, the method ends.

At 510 through 530, the examination of the base code alone, in view of the safety properties, is sufficient to yield the idioms of the code. The idioms can be recognized from a given base code even without knowing the templates that produced the code. This aspect provides two additional benefits. First, it allows the technique to be applied to black-box code generators. Second, it also allows for optimizations. This is due to the fact that as long as the resulting code can be described by patterns, neither the specific optimizations nor their order matter.

The identification of idioms draws from the fact that the automatically generated codes are highly idiomatic. Automated code generators derive lower-level code from higher-level, declarative specifications. Approaches range from deductive synthesis to template meta-programming. However, the aspects of the present invention are independent of both a specific approach and the specification language. This draws from the fact that an automatic code generator usually generates highly idiomatic code. Intuitively, idiomatic code exhibits some regular structure beyond the syntax of the programming language and uses similar constructions for similar problems. Manually written code also tends to be idiomatic, but the idioms used vary with the programmer. Automated generators eliminate this variability because they derive code by combining a finite number of building blocks.

At 540, the formalization of the idioms as patterns is performed. Neither missed idioms nor wrong patterns can compromise the assurance given by the safety proofs because the inferred annotations remain untrusted.

The code generator receives the model of a physical entity and uses internal templates of the code generator to generate the code corresponding to the model. The idioms are utilized by the system and methods of the present invention to determine the interface between the code generator and the inference algorithm. For each generator and safety property, the approach thus uses a customization step in which the relevant idioms are identified and formalized as patterns.

At 550, the method exploits the idiomatic nature of auto-generated code in order to automatically infer logical annotations. Annotations are used in order to allow the automatic formal verification of the safety properties without requiring access to the internals of the code generator. Annotations also make a precise analysis possible. The approach is independent of the particular generator used, and is customized by the appropriate set of patterns.

Traditional verification methods simply search for existing bugs and provide them to the user. Techniques which conclusively demonstrate the absence of bugs are said to perform certification. In an independent verification and validation (IV&V) context, the larger picture of certification must be considered, of which formal verification is a part. Therefore, aspects of the present invention produce assurance evidence which can be checked either by machines, during proof checking, or by humans, during code reviews. An independent entity is able to scrutinize the verification that was performed.

In one instance, following the plug-in philosophy, the system acts as an extension of the generator, and is therefore closely integrated from the user's perspective. At the same time, the implementation does not require a deep integration with the internal operations of the generator.

The following sections describe the components of the system such as the style of safety properties which it can check, the inference of annotations, and the creation and discharge of verification conditions.

Safety Properties

Certification can be supported by formally verifying that the generated code is free of violations of specific safety properties, for example, safety assumptions and requirements 120 of FIG. 1 or those provided by the safety module 320 of FIG. 3A. Aspects of the present invention allow the verification of various kinds of safety properties such as language-specific safety properties, domain-specific safety properties and project-specific and application-specific safety properties. Language-specific properties concern those safety aspects of the code which only depend upon the semantics of the programming language. Examples include memory safety, for example, absence of array bounds violations, variable initialization, and scoping requirements. Domain-specific properties relate to details which are specific to the use of a given code generator in a particular domain. Project-specific and application-specific properties talk about guarantees for a family of applications or a single application, respectively. For example, flight-rules can be considered to include typical project-specific properties. Some examples, of safety properties include initialization safety and array-bounds safety. Initialization safety ensures that each variable or individual array element has been explicitly assigned a value before it is used. Array-bounds safety requires each access to an array element to be within the specified upper and lower bounds of the array, and is a typical example of a language-specific property. Matrix symmetry requires certain two-dimensional arrays to be symmetric. Sensor input usage is a guidance, navigation and control (GN&C) specific property which is a variation of the general initialization property guaranteeing that each sensor reading passed as an input to a state estimation algorithm is actually used during the computation of the output estimate. Another example, from the data analysis domain, ensures that certain one-dimensional arrays represent normalized vectors such that their contents add up to one.

Patterns and Pattern Matching

Patterns can be used to capture the idiomatic code structures and pattern matching to find the corresponding code locations. Each pattern specifies a class of code fragments that are treated similarly by the methods of the invention. The pattern language is a tree-based regular expression language. It supports matching of tree literals, wildcards, and regular operators for optional and non-empty patterns, as well as alternation, concatenation and data flow. One difference with XPath and similar languages is that meta-variables are used in patterns to introduce context dependency. In other words, a uninstantiated meta-variable matches any term but it then becomes instantiated and subsequently matches only other instances of the matched term.

The patterns are able to concisely capture the algorithmic variability which is produced by typical code generators.

Annotation Inference

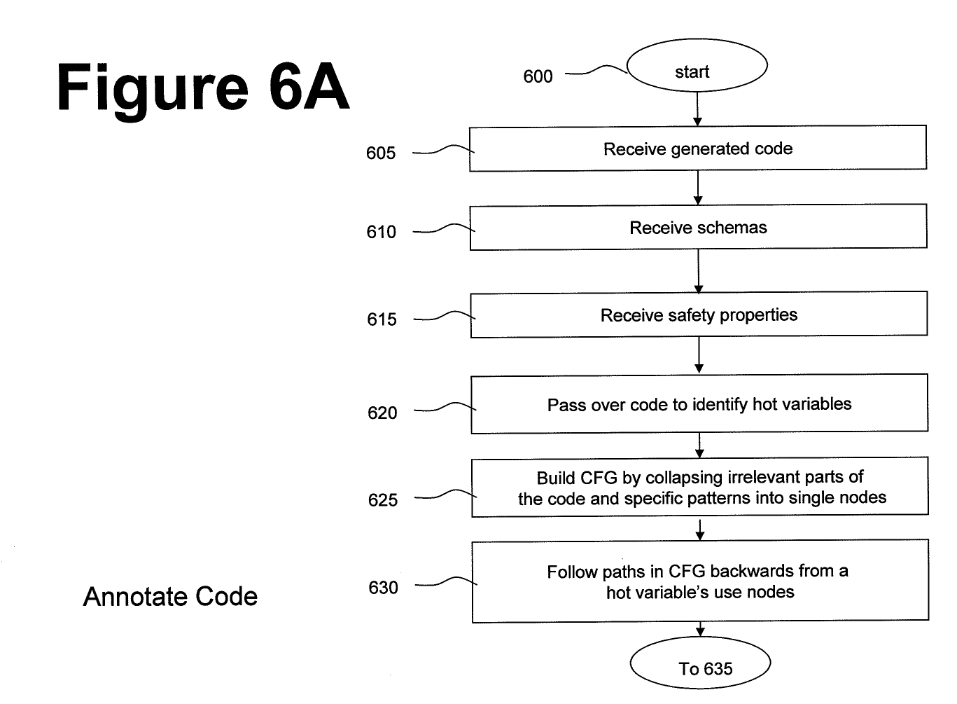

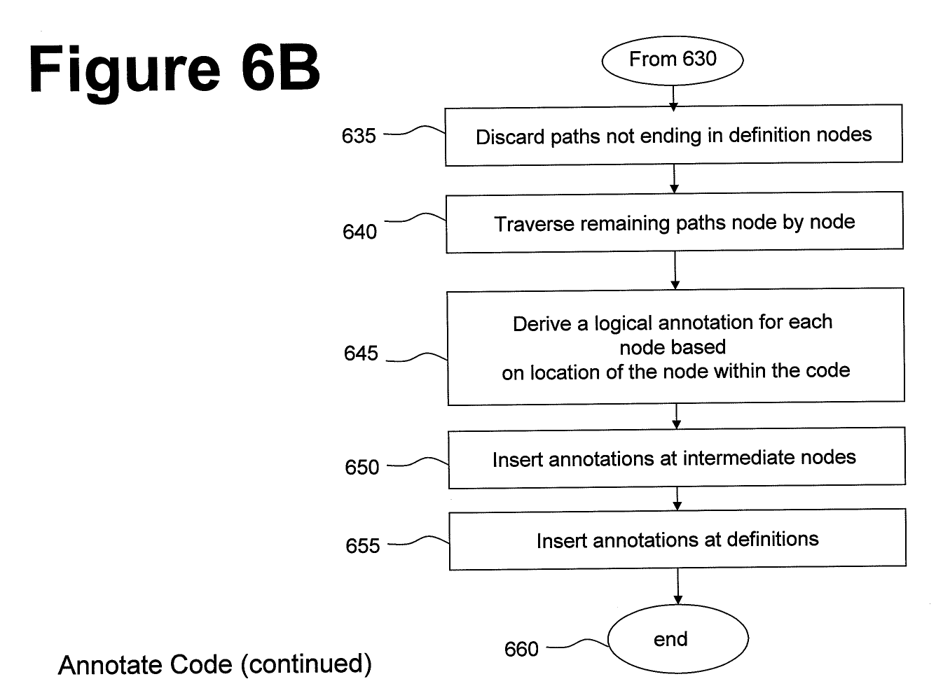

FIG. 6A and FIG. 6B show a flow chart of a method for generating inferred annotations and inserting inferred annotations in an auto-generated code.

The method shown in FIGS. 6A and 6B may be carried out by the inference engine 363 of FIG. 3B.

The method begins at 600.

At 605, an automatically generated code is received.

At 610, schemas are obtained from a schema compiler.

At 615, safety properties are obtained from a safety module.

At 620, the inference generation method of the inference engine first scans the code generated by the code generator for relevant variables. It does so by passing through the program to determine which variable uses are essential or “hot”, i.e., for which there are barriers to the information flow along the paths to all definitions.

At 625, for each hot variable, the inference generation method builds an abstracted CFG where irrelevant parts of the code and specific patterns are collapsed into single nodes.

At 630, the inference generation method follows paths in the CFG backwards from the variable's use nodes until it encounters either a cycle or a definition node for the variable.

At 635, paths that do not end in a definition are discarded.

At 640, the remaining paths are traversed node by node.

At 645, a logical annotation is derived for each node based on the CFG and the safety property corresponding to the node.

At 650, annotations are added to all intermediate nodes that otherwise constitute barriers to the information flow.

At 655, the definitions themselves are annotated.

At 660, the method ends.

For an arbitrary code, such as a manually written code, it is difficult to automatically generate the required annotations and most annotations must be provided by the user. This may be a prohibitively tedious and costly task. However, code generators produce highly structured and idiomatic codes that exhibit some regular structure and use similar constructions for similar problems. Consequently, only a few, standardized annotations may be used.

A generic pattern language can describe these code idioms. The patterns permit annotation schemas to be defined to encapsulate certification cases for matching code fragments. The annotation schemas are then applied using a combination of planning and aspect-oriented techniques to produce an annotated program, which can then be certified in a Hoare-style framework. Conformance of generated code with a range of safety properties can be automatically checked. The inference engine is able to infer annotations for code generated by several code generators and can automatically prove the code safe.

Hoare-Style Safety Certification

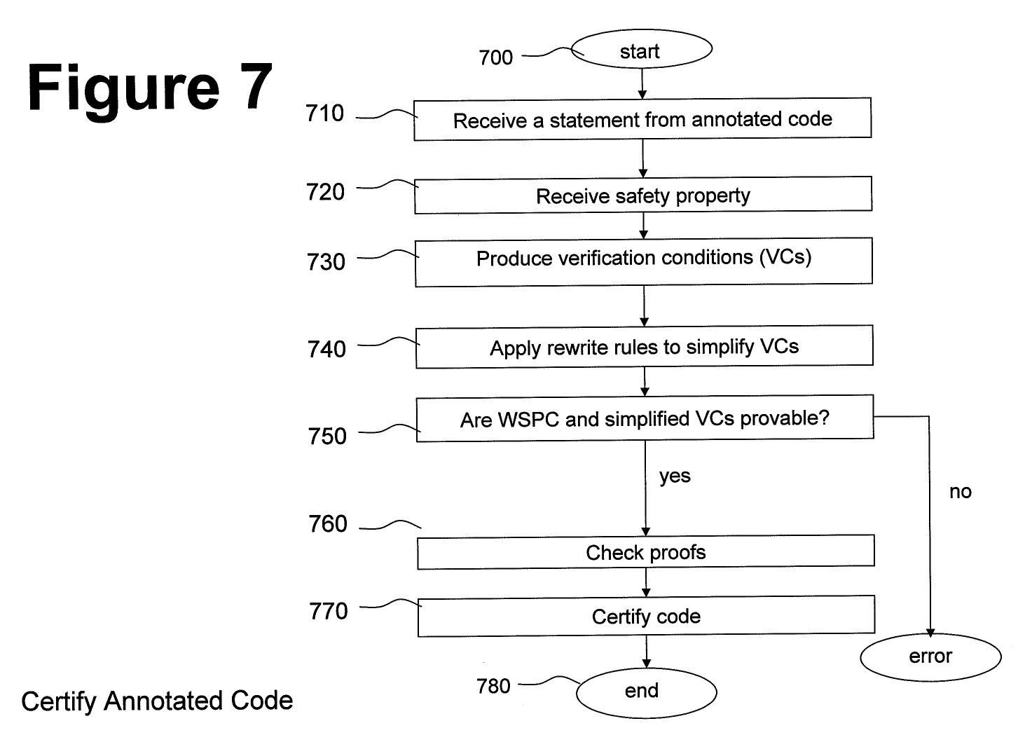

FIG. 7 shows a flow chart of a method of carrying out Hoare Style certification in coordination with techniques described here.

The certification approach of the system shown in FIG. 3A and FIG. 3B uses the Hoare-style framework to prove the safety properties given by the safety module 320. The Hoare logic is based on proof rules that derive triples of the form {P}C{Q}, meaning “if pre-condition P holds before execution of statement C, then Q holds after.” For each safety property and each statement a corresponding rule is given. The VCG 371 then applies the rules to a program, such as the annotated code that is input to the VCG 371 from the annotation inference engine 360, and produces a number of logical statements or proof obligations, also called the verification conditions or VC.

The Hoare-style framework requires a large amount of logical annotations attached to statements of the code, but correctness of the proofs does not depend on correctness of the annotations. As such, the annotation may be untrusted and the system would still function. Further, the annotations can be inferred without compromising the safety guarantees provided by the certification tool.

For each notion of safety, the appropriate safety property and a corresponding policy can be formulated. In particular, the safety policy can be constructed systematically by instantiating a generic rule set that is derived from the standard rules of the Hoare calculus. The basic idea is to extend the standard environment of program variables with a “shadow” environment of safety variables which record safety information related to the corresponding program variables. The rules are then responsible for maintaining this environment and producing the appropriate VCs. This is done using a family of safety substitutions that are added to the normal substitutions, and a family of safety conditions that are added to the calculated weakest preconditions (WPCs). Safety certification then starts with the outermost post-condition and computes the weakest safety precondition (WSPC), i.e., the WPC together with all applied safety conditions and safety substitutions. If the program is safe then its WSPC will be provable without any assumptions.

The method shown in FIG. 7 may be described with respect to the system of FIG. 3A and FIG. 3B. The steps of the method are shown as consecutive for ease of description. Some of the steps, however, may be carried out simultaneously.

The method begins at 700.

At 710, a statement from the annotated code is received at the VCG 371.

At 720, a safety property is received at the VCG 371 from the safety module 320 that corresponds to the statement.

At 730, the VCG 371 produces the verification conditions or VCs by finding rules corresponding to a code statement and a corresponding safety property.

At 740, the simplifier 373 applies a set of rewrite rules to simplify the VCs.

At 750, the ATP 375 determines whether the WSPC and simplified VCs are provable given the axioms and lemmas provided by the domain theory module 379 and generates proofs where provable.

At 760, the proofs are checked by the proof checker 377.

At 770, if the WSPC and simplified VCs are found to be provable and the proofs checks out, the annotated code is certified.

At 780, the method ends.

The VCG 371 implements the semantics of the programming language used by the code generator 350 and the proof rules of the safety module 320.

The VCG 371 traverses the annotated code, provided by the inference engine 371, and applies the rules of the calculus to produce VCs. These are then simplified at the simplifier 373, completed by an axiomatization of the background theory, provided by the domain theory module 379, and given to an off-the-shelf high-performance ATP, such as the ATP 375. If all obligations of the proof rules are proven, then it is guaranteed that the safety property of the safety policy module 440 is obeyed and the resulting proofs comprise the evidence for that. The VCG 371 can be seen, therefore, as performing a compositional verification of the property. Note that the ATP 375 has no access to the program internals. As a result, pertinent pieces of information are taken from the annotations, which become part of the VCs.

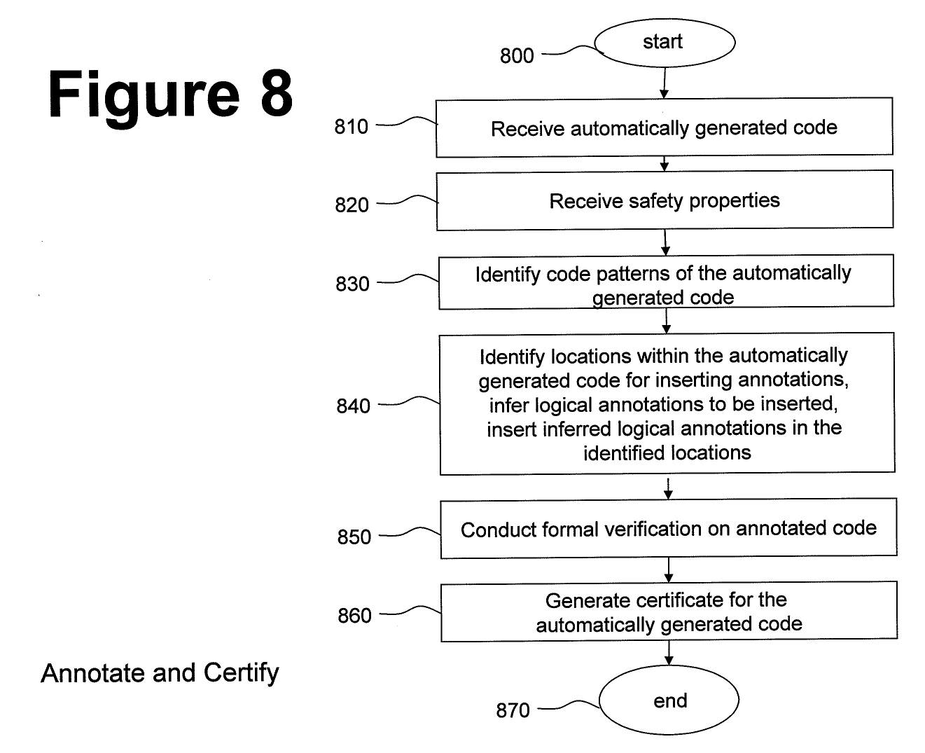

FIG. 8 shows a flow chart of another overview of a method of verification of an auto-generated code using generic post-generation annotation inference.

At 800, the method begins.

At 810, an automatically generated code is received.

At 820, safety properties are received.

At 830, code patterns of the automatically generated code are identified. For each safety property, there is a library of patterns that are available to be matched to the code patterns.

At 840, nodes within the code where the annotations are to be inserted are identified, the logical annotations needed for verification of the code are inferred, and the inferred logical annotations are inserted at the identified nodes and an annotated code is obtained.

At 850, formal verification is conducted on the annotated node.

At 860, a certificate for the automatically generated code is produced.

At 870, the method ends.

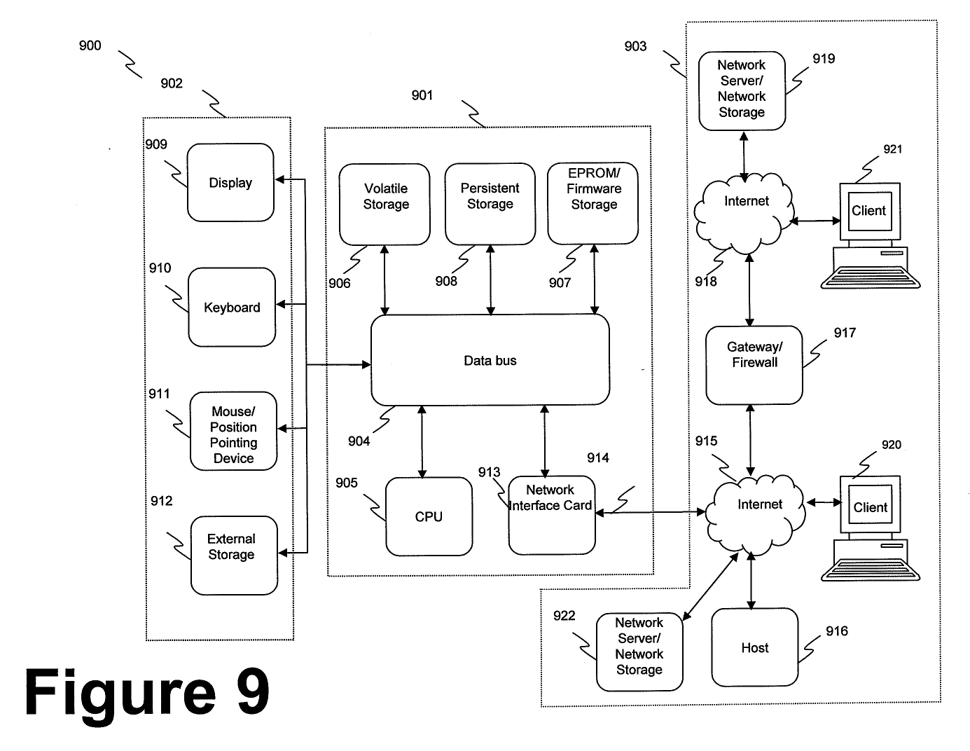

FIG. 9 shows an exemplary embodiment of a computer platform upon which the inventive system may be implemented.

The system 900 includes a computer/server platform 901, peripheral devices 902 and network resources 903.

The computer platform 901 may include a data bus 904 or other communication mechanism for communicating information across and among various parts of the computer platform 901, and a processor 905 coupled with bus 901 for processing information and performing other computational and control tasks. Computer platform 901 also includes a volatile storage 906, such as a random access memory (RAM) or other dynamic storage device, coupled to bus 904 for storing various information as well as instructions to be executed by processor 905. The volatile storage 906 also may be used for storing temporary variables or other intermediate information during execution of instructions by processor 905. Computer platform 901 may further include a read only memory (ROM or EPROM) 907 or other static storage device coupled to bus 904 for storing static information and instructions for processor 905, such as basic input-output system (BIOS), as well as various system configuration parameters. A persistent storage device 908, such as a magnetic disk, optical disk, or solid-state flash memory device is provided and coupled to bus 901 for storing information and instructions.

Computer platform 901 may be coupled via bus 904 to a display 909, such as a cathode ray tube (CRT), plasma display, or a liquid crystal display (LCD), for displaying information to a system administrator or user of the computer platform 901. An input device 910, including alphanumeric and other keys, is coupled to bus 901 for communicating information and command selections to processor 905. Another type of user input device is cursor control device 911, such as a mouse, a trackball, or cursor direction keys for communicating direction information and command selections to processor 904 and for controlling cursor movement on display 909. This input device typically has two degrees of freedom in two axes, a first axis (e.g., x) and a second axis (e.g., y), that allows the device to specify positions in a plane.

An external storage device 912 may be connected to the computer platform 901 via bus 904 to provide an extra or removable storage capacity for the computer platform 901. In an embodiment of the computer system 900, the external removable storage device 912 may be used to facilitate exchange of data with other computer systems.

The invention is related to the use of computer system 900 for implementing the techniques described herein. In an embodiment, the inventive system may reside on a machine such as computer platform 901. According to one embodiment of the invention, the techniques described herein are performed by computer system 900 in response to processor 905 executing one or more sequences of one or more instructions contained in the volatile memory 906. Such instructions may be read into volatile memory 906 from another computer-readable medium, such as persistent storage device 908. Execution of the sequences of instructions contained in the volatile memory 906 causes processor 905 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 905 for execution. The computer-readable medium is just one example of a machine-readable medium, which may carry instructions for implementing any of the methods and/or techniques described herein. Such a medium may take many forms, including but not limited to, non-volatile media, volatile media, and transmission media. Non-volatile media includes, for example, optical or magnetic disks, such as storage device 908. Volatile media includes dynamic memory, such as volatile storage 906. Transmission media includes coaxial cables, copper wire and fiber optics, including the wires that comprise data bus 904.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, a flash drive, a memory card, any other memory chip or cartridge, or any other medium from which a computer can read.

Various forms of computer readable media may be involved in carrying one or more sequences of one or more instructions to processor 705 for execution. For example, the instructions may initially be carried on a magnetic disk from a remote computer. Alternatively, a remote computer can load the instructions into its dynamic memory and send the instructions over a telephone line using a modem. A modem local to computer system 900 can receive the data on the telephone line and use an infra-red transmitter to convert the data to an infra-red signal. An infra-red detector can receive the data carried in the infra-red signal and appropriate circuitry can place the data on the data bus 904. The bus 904 carries the data to the volatile storage 906, from which processor 905 retrieves and executes the instructions. The instructions received by the volatile memory 906 may optionally be stored on persistent storage device 908 either before or after execution by processor 905. The instructions may also be downloaded into the computer platform 901 via Internet using a variety of network data communication protocols well known in the art.

The computer platform 901 also includes a communication interface, such as network interface card 913 coupled to the data bus 904. Communication interface 913 provides a two-way data communication coupling to a network link 914 that is connected to a local network 915. For example, communication interface 913 may be an integrated services digital network (ISDN) card or a modem to provide a data communication connection to a corresponding type of telephone line. As another example, communication interface 913 may be a local area network interface card (LAN NIC) to provide a data communication connection to a compatible LAN. Wireless links, such as well-known 802.11a, 802.11b, 802.11g and Bluetooth may also be used for network implementation. In any such implementation, communication interface 913 sends and receives electrical, electromagnetic or optical signals that carry digital data streams representing various types of information.

Network link 913 typically provides data communication through one or more networks to other network resources. For example, network link 914 may provide a connection through local network 915 to a host computer 916, or a network storage/server 917. Additionally or alternatively, the network link 913 may connect through gateway/firewall 917 to the wide-area or global network 918, such as an Internet. Thus, the computer platform 901 can access network resources located anywhere on the Internet 918, such as a remote network storage/server 919. On the other hand, the computer platform 901 may also be accessed by clients located anywhere on the local area network 915 and/or the Internet 918. The network clients 920 and 921 may themselves be implemented based on the computer platform similar to the platform 901.

Local network 915 and the Internet 918 both use electrical, electromagnetic or optical signals that carry digital data streams. The signals through the various networks and the signals on network link 914 and through communication interface 913, which carry the digital data to and from computer platform 901, are exemplary forms of carrier waves transporting the information.

Computer platform 901 can send messages and receive data, including program code, through the variety of network(s) including Internet 918 and LAN 915, network link 914 and communication interface 913. In the Internet example, when the system 901 acts as a network server, it might transmit a requested code or data for an application program running on client(s) 920 and/or 921 through Internet 918, gateway/firewall 917, local area network 915 and communication interface 913. Similarly, it may receive code from other network resources.

The received code may be executed by processor 905 as it is received, and/or stored in persistent or volatile storage devices 908 and 906, respectively, or other non-volatile storage for later execution. In this manner, computer system 901 may obtain application code in the form of a carrier wave.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, perl, shell, PHP, Java, Prolog, etc.

While the present invention has been particularly shown and described with reference to exemplary embodiments thereof, it will be understood by those of ordinary skill in the art that various changes in form and details may be made therein without departing from the spirit and scope of the present invention as defined by the following claims. The exemplary embodiments should be considered in descriptive sense only and not for purposes of limitation. Therefore, the scope of the invention is defined not by the detailed description of the invention but by the appended claims and their equivalents, and all differences within the scope will be construed as being included in the present invention.

What is claimed is:

1. A computer-implemented method for verification of an automatically generated computer code, the method comprising:
receiving the automatically generated code;
receiving safety properties;
automatically annotating the automatically generated code to obtain an annotated code; and
conducting verification on the annotated code to generate a certificate for the automatically generated code,
wherein the annotating includes:
identifying code patterns of the automatically generated code;
describing code constructs of the automatically generated code to locate, based on the code patterns and the safety properties, first locations within the automatically generated code;
inferring logical annotations to be inserted at the first locations within the automatically generated code; and
inserting the logical annotations in the automatically generated code at the first locations to obtain the annotated code.

2. The method of claim 1,
wherein the describing code constructs includes:
building control flow diagrams of the automatically generated code based on the safety properties; and
traversing the control flow diagrams on paths following from use nodes backwards to all definition nodes corresponding to each use node,
wherein the first locations are located at intermediate nodes along the paths constituting barriers to information flow between the definition nodes and the use nodes, and
wherein the first locations are located at the definition nodes.

3. The method of claim 1, wherein the identifying code patterns of the automatically generated code includes:
receiving safety properties;
identifying idioms in the automatically generated code;
receiving generic patterns from a pattern library for each safety property;
formalizing the idioms as the code patterns by matching the idioms to the generic patterns; and
building a control flow diagram of the automatically generated code.

4. The method of claim 1, wherein the inferring logical annotations includes:
receiving annotation schemas from a schema library;
receiving the safety properties;
deriving the logical annotations responsive to a position of the first locations within the automatically generated code.

5. The method of claim 1, further comprising:
customizing the verification to reduce unwarranted warnings by increasing precision including:
verifying a sample of the automatically generated code for the safety properties;
indicating missing schemas in a form of errors being traced to specific lines of the automatically generated code, the missing schemas corresponding to missing annotations;
identifying code fragments of the automatically generated code corresponding to the missing schemas;
generalizing the code fragments as high-level patterns to capture code variability;
writing annotation schemas based on the high-level patterns, extended with pre-defined annotation construction operators and embodying standard induction principles; and
writing additional annotation schemas until the desired precision is achieved.

6. The method of claim 1, further comprising:
generating a detailed report of the verification using the logical annotations to provide an explanation of the verification to a human user or a machine by combining logical annotation inference information with automatic theorem proving information.

7. The method of claim 1, wherein a combination of planning and aspect-oriented programming techniques is used for the inserting of the logical annotations in the automatically generated code.

8. The method of claim 1,
wherein formal logic is used to specify the safety properties, the safety properties being separated from an annotation engine for the annotating and a certification engine for the conducting verification, and
wherein the annotation engine and the certification engine are customized to project-specific flight rules.

9. The method of claim 1, wherein the conducting verification includes:
receiving the annotated code;
receiving the safety properties;
generating verification conditions responsive to the annotated code and the safety properties;
simplifying the verification conditions; and
proving that the automatically generated code satisfies the safety properties using the logical annotations,
wherein the conducting verification is conducted automatically.

10. The method of claim 9,
wherein the annotating uses untrusted elements,
wherein the generating verification conditions uses a trusted element,
wherein the simplifying the verification conditions uses a trusted element,
wherein the proving uses an untrusted element, and
wherein trustworthiness of the trusted components is responsive to the safety properties.

11. A system for verification of an automatically generated computer code, the system comprising:
an annotation engine for receiving the automatically generated code from a code generator, receiving safety requirements, and generating annotated code; and
a certification engine coupled to the annotation engine and for receiving the annotated code from the annotation engine and generating a certificate corresponding to the annotated code,
wherein the annotation engine and the certification engine perform independently from internal templates of the code generator, and
wherein the certificate is provably correct and can be checked by an independent third party, machine or human.

12. The system of claim 11, further comprising:
a model module for providing a model of a physical feature or phenomenon to the code generator;
the code generator for receiving the model from the model module and providing the automatically generated code to the annotation engine, the automatically generated being code representative of the physical feature or phenomenon;
a safety module for providing the safety requirements to the annotation engine and to the certification engine; and
a safety document generator for receiving logical annotation inference information from the annotation engine and receiving automatic theorem proving information from the certification engine and generating a safety document corresponding to the annotated code,
wherein the certificate certifies that the automatically generated code is verified as accurately representative of the model.

13. The system of claim 11, wherein the annotation engine includes:
a schema library including a pattern library and guards and actions, the guards being conditions expressed in terms of variables in code patterns and the actions being calls to annotation construction operations;
a schema compiler for receiving generic patterns from the pattern library;
a control flow graph builder coupled to the schema compiler, the control flow graph builder for receiving the automatically generated code from the code generator and the schemas from the schema compiler and constructing a control flow graph of the automatically generated code; and
an inference engine coupled to the control flow graph builder and to the schema compiler, the inference engine for receiving the automatically generated code and the control flow graph from the control flow graph builder, receiving the schemas from the schema complier, receiving the safety requirements, and generating the annotated note and inference information.

14. The system of claim 13, wherein the certification engine includes:
a verification condition generator for receiving the annotated code from the annotation engine and receiving the safety requirements and generating verification conditions;
a simplifier coupled to the verification condition generator for simplifying the verification conditions;
an automatic theorem prover coupled to the simplifier and for generating proofs of accuracy of the automatically generated code from the verification conditions;
a proof checker coupled to the automatic theorem prover for checking the proofs; and
a domain theory module for providing rules to the simplifier and providing axioms and lemmas to the automatic theorem prover.

15. The system of claim 14,
wherein the annotation engine uses untrusted components,
wherein the automatic theorem prover is an untrusted component,
wherein the verification condition generator is a trusted component,
wherein the simplifier is a trusted component,
wherein the proof checker is a trusted component,
wherein the domain theory module is a trusted component, and
wherein trustworthiness of the trusted components is responsive to the safety requirements.

16. A computer readable medium storing a computer program for verification of an automatically generated computer code, the computer program, when executed by a computer, performs a method comprising:
receiving the automatically generated code;
receiving safety properties;
automatically annotating the automatically generated code to obtain an annotated code; and
conducting verification on the annotated code to generate a certificate for the automatically generated code,
wherein the annotating includes:
identifying code patterns of the automatically generated code;
describing code constructs of the automatically generated code to locate, based on the code patterns and the safety properties, first locations within the automatically generated code;
inferring logical annotations to be inserted at the first locations within the automatically generated code; and
inserting the logical annotations in the automatically generated code at the first locations to obtain the annotated code.
